(19) United States
(12) Patent Application Publication
(10) Pub. No.: US 2015/0048089 A1
(43) Pub. Date: Feb. 19, 2015

(54) Container Lid with Plastic Ring and Method of Manufacture

(71) Applicant: Huhtamaki, Inc., De Soto, KS (US)

(72) Inventor: Ronald D. Robertson, Kansas City, MO (US)

(21) Appl. No.: 14/457,796

(22) Filed: Aug. 12, 2014

Related U.S. Application Data
(60) Provisional application No. 61/865,433, filed on Aug. 13, 2013.

(51) Int. Cl. B65D 43/02; B29D 99/00; B29B 11/02

(52) U.S. Cl. CPC B65D 43/021; B29B 11/02; B29D 99/0096; B29K 2001/00
USPC 220/350; 264/138

(57) ABSTRACT

A container lid is provided having a paperboard dome-shaped central cover portion, a generally flat and horizontal peripheral lid rim extending outwardly around at least part of the cover portion, and a plastic ring circumscribing at least part of the lid rim. The plastic ring includes a horizontal flange and a skirt depending downwardly therefrom. The plastic ring's flange may be semi-permanently attached to the lid rim and may be optionally secured thereto by an adhesive, a polymeric film or a heat seal coating. The plastic ring may be injection molded directly onto the lid rim. A bond formed between the plastic ring's flange and the lid rim may be adapted to be broken by a user such that the plastic ring can be separated from the lid rim upon disposal thereby allowing the paperboard portions of the lid to be discarded separately from the plastic ring.

### CROSS-REFERENCE TO RELATED APPLICATIONS

This Application claims priority to U.S. Provisional Patent Application Ser. No. 61/865,433, filed on Aug. 13, 2013, to Ronald D. Robertson entitled “Pressed Paperboard Lid with Plastic Ring and Method of Manufacture,” currently pending, the entire disclosure of which is incorporated herein by reference.

### BACKGROUND OF THE INVENTION

Containers for food products are well known in the art. Such containers typically include a receptacle and a lid. The lid may be attached to the container in various manners. One example of such a container includes a lid formed of a flat paperboard closure panel and a plastic peripheral ring.

Such previously known container lids are not without shortcomings. For example, when placed over a receptacle, the flat closure panel of the lid will prevent the lid from being attached to the receptacle when food or other contents are heaped or stacked above a peripheral rim of the receptacle. If the contents are loaded into the receptacle such that they extend above a plane formed by the peripheral rim of the receptacle, the flat closure panel comes into interference with the contents, thereby preventing the plastic ring from attaching a top rim of the receptacle.

Additionally, in recent years, continuing efforts have been made to increase the recyclability of packaging, and in particular, food packaging. However, another disadvantage of previously known container lids made of multiple materials (e.g., paperboard and plastic) was that they were not recyclable due to containing multiple materials and were therefore, upon disposal, were placed in waste that was directed for landfills.

Accordingly, a need exists for a lid that permits food or other contents to be heaped or stacked above a peripheral rim of the receptacle to which the lid is attached. A further need exists for a lid made of multiple materials that can be separated so that the materials can be recycled apart from one another.

### SUMMARY OF THE INVENTION

One embodiment of the present invention is directed to a container lid adapted for placement over a container base. The lid may comprise a cover portion having an upwardly projecting or dome-shaped central section, a generally flat and horizontal peripheral lid rim extending outwardly around at least part of the cover portion, and a plastic ring circumscribing at least part of the lid rim. The plastic ring can include a horizontal flange and a skirt depending downwardly therefrom. The plastic ring may also optionally include one or more locking projections extending inwardly from the skirt and a channel defined between an upper surface of each locking projection and a lower surface of the lid rim.

The lid's cover and rim portions may be formed from a paper-based material, including but not limited to, a pressed paperboard material or a molded fiber material. A lower surface of the plastic ring's flange may be semi-permanently attached to an upper surface of the lid rim and may be optionally secured thereto by an adhesive, a polymeric film or a heat seal coating. In one embodiment, the plastic ring is injection molded onto the lid rim. A bond formed between the lower surface of the plastic ring's flange and the upper surface of the lid rim may be adapted to be broken by a user such that the plastic ring can be separated from the lid rim upon disposal. This allows the cover and lid rim portions, which may be formed from a paperboard material, to be discarded separately from the plastic ring.

Another aspect of the present invention is directed to a method of manufacturing the container lid described herein. One embodiment of the method comprises the steps of providing a paperboard material, cutting a blank from the paperboard material, die stamping the blank to form an upwardly extending cover portion and a generally flat and horizontal peripheral lid rim extending around at least part of the cover portion, placing the formed paperboard blank in an injection molding machine, and forming an injection molded plastic ring around at least part of the lid rim.

Other aspects and advantages of the present invention will be apparent from the following detailed description of the preferred embodiments and the accompanying drawing figures.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1 is a side perspective view of a lid having a plastic ring in accordance with one embodiment of the present invention;

FIG. 2 is a partial sectional side view of the lid and plastic ring of FIG. 1;

FIG. 3 is a side perspective view of a container base to which the lid and plastic ring of the present invention may be attached;

FIG. 4 is a partial sectional side view of the lid and plastic ring of FIG. 1 attached to a container base; and

FIG. 5 is an exploded side perspective view of the lid and container base in accordance with one embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

The present invention is directed generally to a container lid 10 having a plastic ring 12 and also to a method of manufacturing same. The container lid 10 is adapted for placement over a receptacle or container base 14. As discussed in greater detail below, the ring 12 facilitates attachment of the lid 10 to the container base 14. The ring 12 may be separated from the remained of the lid 10 upon disposal so that the ring 12 and the remainder of the lid 10 may be recycled and/or composted separately from one another.

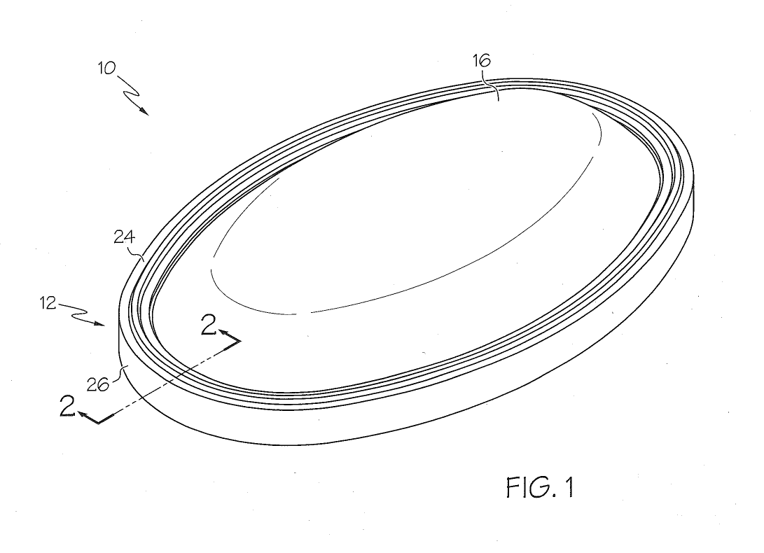

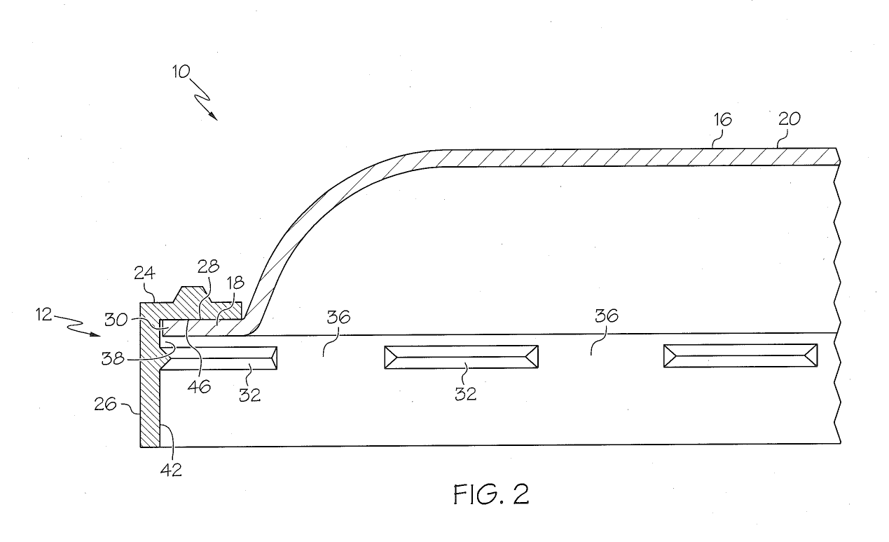

Referring to the figures, FIG. 1 illustrates a lid 10 in the form of an assembly comprising a central cover portion 16 and the peripheral ring 12. FIG. 2 depicts a cover portion 16 having an upwardly projecting central section and a generally flat and horizontal peripheral rim 18 extending radially and outwardly at least partially or fully around the cover portion 16. In one embodiment, the cover portion 16 is generally dome-shaped. However, it will be appreciated that the cover portion 16 need not be dome-shaped and may take on any other suitable shape. The cover 16 and rim 18 portions of the lid 10 may be integrally formed of any suitable material, including but not limited to a cellulosic or fiber-containing material, a paper-based material, a plastic material, a metallic material or any other suitable material now known or hereafter developed.

The term “paper,” as used herein, is a broad term and includes without limitation all types of paper products, such as paperboard, kraft paperboard, reprocessed paperboard, molded paper, molded fiber, pulp slurry, corrugated paper, cardboard, coated paper, paper laminates and multi-ply paper. The term “pulp slurry,” as used herein may include, for example, an aqueous slurry containing cellulose or cellulosic fiber derived from a plant or wood pulping process or paper recycling process. The term “pressed paperboard,” as used herein, is a broad term and includes without limitation paper that is constructed from a generally planar paperboard blank and deformed into shape under pressure. In an embodiment wherein the cover 16 and rim 18 portions of the lid 10 are formed of pressed paperboard, generally radial score lines may be formed in the paperboard blank prior to the blank being formed into shape. The blank can then be formed into shape by a forming press that includes upper and lower heated dies having corresponding male and female surfaces. During the forming process, pleats may be formed at the score lines.

The lid 10 may further include printing or other graphics on an upper exterior surface 20 of the cover portion 16. One or more of the inside and outside surfaces of the lid 10 may be coated with a polymeric coating, a polymeric film or another material or liner suitable for impeding liquids or moisture from penetrating therethrough.

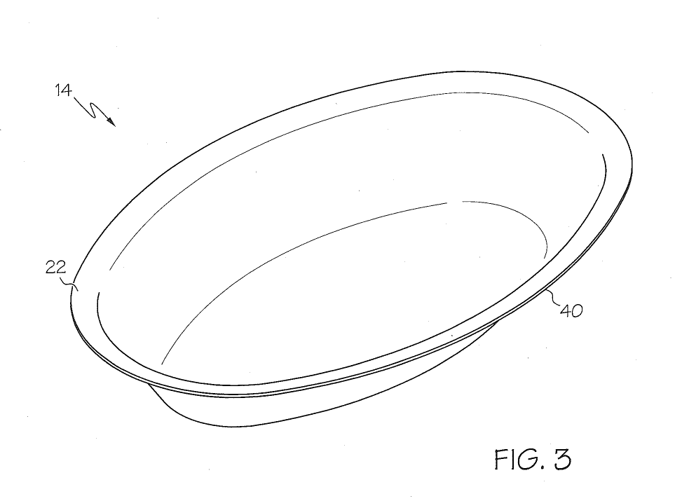

FIG. 3 illustrates a container base 14, to which the lid 10 may be releasably attached. The container base 14 may take any suitable shape and may be in the form of a bowl, carton or other receptacle. In one embodiment, the container base 14 is identical to, or similar in nature to, what is commonly referred to as a “burrito bowl” at various eating establishments. Like the cover 16 and rim 18 portions of the lid 10, the container base 14 can be constructed of any suitable material, including but not limited to a cellulosic or fiber-containing material, a paper-based material, a plastic material, a metallic material or any other suitable material now known or hereafter developed. One or more of the inside and outside surfaces of the container base 14 may be coated with a polymeric coating, a polymeric film or another material or liner suitable for impeding liquids or moisture from penetrating therethrough. In one preferred embodiment, the container base 14 is formed of a molded fiber material and the cover 16 and rim 18 portions of the lid 10 are formed of a pressed paperboard material.

As shown in FIG. 3, the container base 14 includes a generally flat and horizontal peripheral rim 22 extending radially and outwardly at least partially or fully therearound that corresponds generally to the rim 18 of the lid 10. When the lid 10 is attached to or otherwise covering the container base 14, the rim 18 of the lid 10 mates with the rim 22 of the container base 14. The lid's rim 18 may include a circumscribing outer edge 30 that is generally identical or similar in size and/or shape to a circumscribing outer edge 40 of the container base's rim 22. In fact, in one optional embodiment, the paper-based portions (i.e., the cover 16 and rim 18) of the lid 10 are generally identical to that of the container base 14. In other words, the paper-based portion of the lid 10 may simply be an inverted or overturned container base 14, both of which may be constructed of a pressed paperboard material or a molded fiber material, for example. In such an embodiment, the paper-based portion of the lid 10 may be a mirror image of, and interchangeable with, the container base 14.

Turning attention now to the ring 12, the ring 12 may comprise a generally horizontal flange 24 and a generally downwardly extending peripheral skirt 26. The ring 12 circumscribes all or at least a portion of the lid rim 18 and may be constructed of a plastic, polymeric material, molded fiber material, or other suitable material now known or hereafter developed. In one embodiment, the ring 12 is formed of an injected molded plastic.

As shown in FIG. 2, the ring 12 is mated with the rim 18 portion of the lid 10. A lower surface 46 of the flange 24 portion of the ring 12 may be seated on an upper surface 28 of the lid's rim 18. The lower surface 46 of the ring's flange 24 may optionally be attached to the upper surface 28 of the lid's rim 18 by an adhesive, a polymeric film, a heat seal coating or other suitable material. In an alternative embodiment, the ring 12 is formed to include lugs or undercuts (in addition to those shown and referenced as 32) specifically for mechanically entrapping an outer edge 30 of the lid's rim 18. In another embodiment, as discussed below, the ring 12 is injection molded directly onto the lid 10 which may attach it, at least semi-permanently, to the lid's rim 18. In another alternative embodiment, the ring 12 may be free-floating and not attached to the lid's rim 18 at all. It will be appreciated that the ring 12 may be attached, coupled, affixed or otherwise mated with the rim 18 of the lid 10 in any other suitable manner now known or hereafter developed.

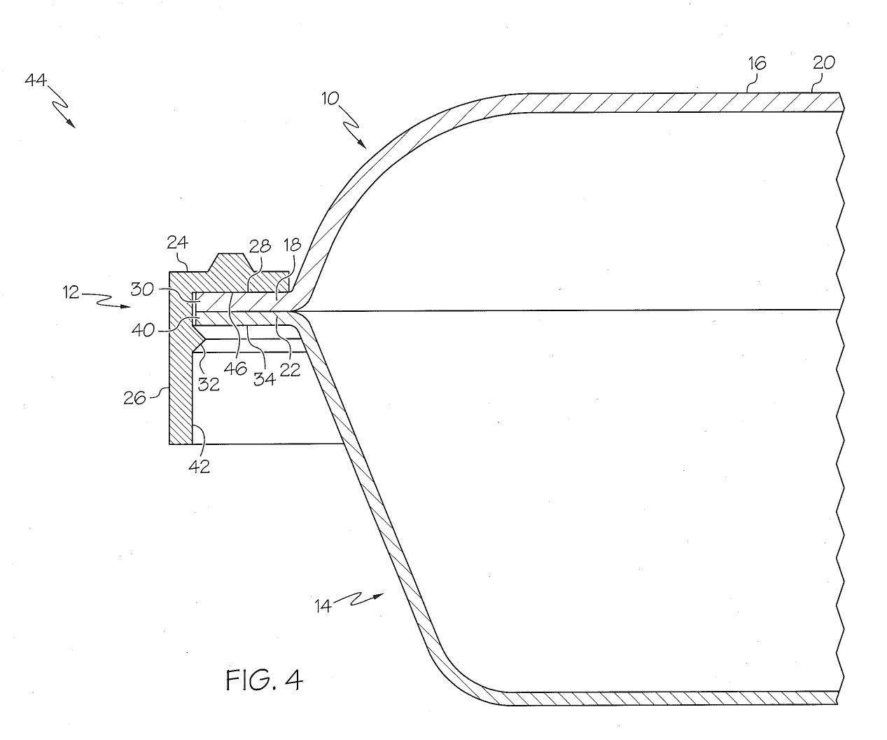

As illustrated in FIGS. 2 and 4, the skirt 26 portion of the ring 12 may be provided with one or more inwardly extending ribs, barbs, undercuts, lugs or projections 32 for engaging an undersurface 34 of the container's rim 22 to secure the lid 10 to the container 14 in an interlocking fashion. The ring 12 may include a single projection 32 that extends around the entire interior periphery of the skirt 26 or may include a plurality of peripherally-spaced projections 32 having gaps 36 therebetween where no projection is present. A channel 38 is formed between an upper surface or top side of each projection 32 and the bottom side of the lid's rim 18. The channel 38 is sized and shaped to permit engagement with the outer edge 40 of the container base's rim 22. As demonstrated in FIG. 4, the outside edge 40 of the container's rim 18 snaps into the channel 38 and is retained in the channel 38 so as to lock the lid 10 to the container 14. The lid 10 and container 14 may be in releasable snapping engagement with one another. When a consumer desires to gain access to the contents (e.g., food) within the container 14, the consumer may grasp a lower portion 42 of the lid's skirt 26 and simultaneously pull outwardly and upwardly in order to disengage the outer edge 40 of the container's rim 22 from the lid's channel 38.

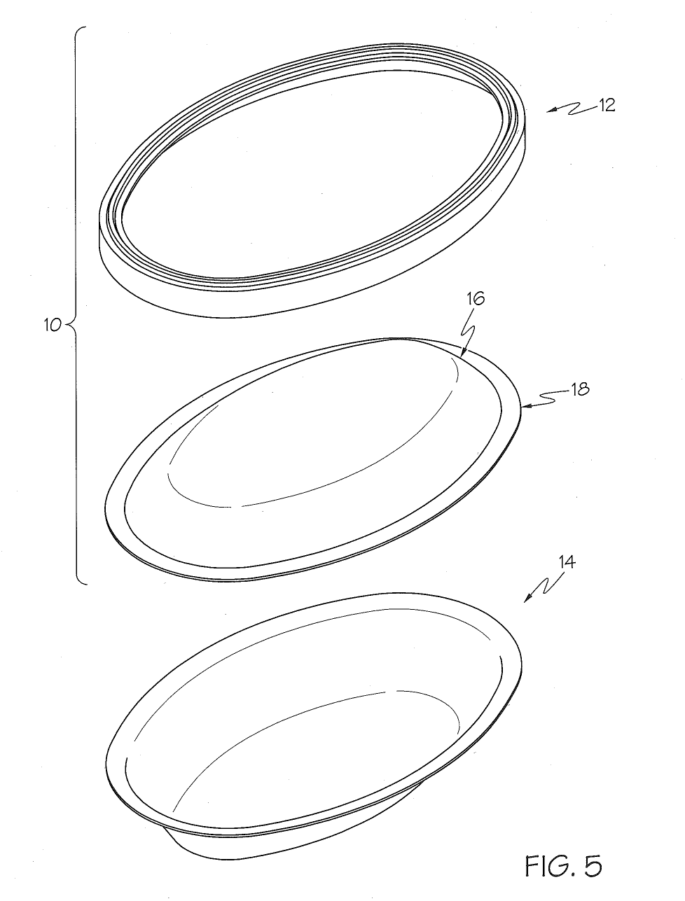

In the embodiment where the cover 16 and rim 18 portions of the lid 10 are constructed of a pressed paperboard material and the container 14 is constructed of a molded fiber material, the resulting container 14 and lid 10 assembly 44 may be fully recyclable upon disposal. FIG. 5 illustrates the lid 10 separated from the container base 14 and further depicts the ring 12 separated from the cover 16 and rim 18 portions of the lid 10. The plastic ring 12 is such that it can be easily and cleanly separated from the paperboard lid rim 18 by a restaurant consumer upon disposal after use, such that the paperboard portion of the lid 10 can be recycled or composted separately from the plastic ring 12. The molded fiber container 14 is also recyclable or compostable. The paperboard portion of the lid 10 and the molded fiber container 14 may be placed in one recycle bin, while the plastic ring 12 may be placed in a separate recycle bin. Alternatively, each of the three components may be placed in their own dedicated recycle bins so that the paperboard, molded fiber and plastic materials are all separate from one another.

Turning now to the method of manufacture, the pressed paperboard cover 16 and rim 18 portions of the lid 10 can be formed in accordance with well-known manufacturing processes, as set forth above. In one embodiment, the pressed paperboard lid 12 is formed in a process similar or identical to that used in forming pressed paperboard plates or bowls. The cover 16 portion of the lid 10 can be formed in a die stamping operation. This may be necessary to form an upwardly extending or dome-shaped cover portion 16 of the lid 10 having a significant depth. The lid rim 18 is also formed in the die-stamping operation. The paperboard portions of the lid 10 may be formed in the typical fashion such that it includes creases or pleats so that it takes the shape somewhat typical of a normal pressed paperboard plate or bowl, albeit optionally having a dome shape with a cross-sectional profile that is deeper than that of a normal plate. In that regard, the lid 10 may be similar in nature to an upside down plate or bowl. The dome shape of the cover portion 16 provides the container 14 and lid 10 assembly 44 with a capacity that is greater than if the cover portion 16 were flat. The dome-shaped cover portion 16 allows the lid 10 to cover contents that heaped or stacked above a horizontal plane formed by the container's rim 22. Further, one of the primary differences between the lid 10 and the typical paperboard plate or bowl is that the lid 10 may have printing on its upper exterior surface 20. It will be understood that the top surface 20 of the lid 10 is analogous to the bottom surface of the typical paperboard plate or bowl. Portions of the top surface 20 of the lid 10 may be generally flat and/or may take on a convex or concave shape or have indentions or protrusions formed therein, as desired.

Once the paperboard cover 16 and rim 18 portions of the lid 10 are formed, they can be placed in an injection molding machine such that the plastic ring 12 may be formed around the lid rim 18. In one embodiment, the plastic ring 12 is semi-permanently affixed to the lid's rim 18 via an adhesive, a polymeric film or a heat seal coating which may be applied to the upper surface 28 on the lid's rim 18 prior to the paperboard portions of the lid 10 being placed in the injection molding machine. Once complete, the lid 10 may be kept separate from the container 14 until a product (e.g., food) is placed in the container 14. At that time, the lid 10 may be snappingly engaged with the container 14 to cover and contain the contents within the container 14.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A container lid adapted for placement over a container base having a generally flat and horizontal peripheral container rim, said lid comprising:
a cover portion having an upwardly projecting central section;
a generally flat and horizontal peripheral lid rim extending outwardly around at least a portion of said cover portion; and
a plastic ring circumscribing at least a portion of said lid rim, said plastic ring including a horizontal flange and a skirt depending downwardly therefrom.

2. The lid of claim 1, wherein said cover portion is generally dome-shaped.

3. The lid of claim 1, wherein said cover portion and said lid rim are constructed of a pressed paperboard material.

4. The lid of claim 1, wherein said cover portion and said lid rim are constructed of a molded fiber material.

5. The lid of claim 1, wherein a lower surface of said flange of said plastic ring is semi-permanently attached to an upper surface of said lid rim.

6. The lid of claim 5, wherein said lower surface of said flange of said plastic ring is semi-permanently attached to said upper surface of said lid rim by at least one of an adhesive, a polymeric film and a heat seal coating.

7. The lid of claim 5, wherein said plastic ring is injection molded onto said lid rim.

8. The lid of claim 5, wherein a bond formed between said lower surface of said flange of said plastic ring and said upper surface of said lid rim is adapted to be broken by a user such that said plastic ring may be separated from said lid rim upon disposal.

9. The lid of claim 1, wherein said cover portion and said lid rim can discarded separately from said plastic ring upon disposal.

10. The lid of claim 1 further comprising print disposed on an upper exterior surface of said cover portion.

11. The lid of claim 1, wherein said lid rim includes a circumscribing outer edge that is generally identical in shape to a circumscribing outer edge of said container rim.

12. The lid of claim 1 further comprising a locking projection extending inwardly from said skirt, and a channel defined between an upper surface said locking projection and a lower surface of said lid rim.

13. The lid of claim 12, wherein said channel is sized and shaped to permit engagement with an outer edge of said container base rim.

14. A container lid adapted for placement over a container base having a generally flat and horizontal peripheral container rim, said lid comprising:
a pressed paperboard cover portion having a generally dome-shaped central section;
a generally flat and horizontal peripheral pressed paperboard lid rim extending outwardly around at least a portion of said cover portion; and
a plastic ring circumscribing at least a portion of said lid rim, said plastic ring including a horizontal flange and a skirt depending downwardly therefrom;
wherein a lower surface of said flange of said plastic ring is semi-permanently attached to an upper surface of said lid rim such that said plastic ring can be separated from said lid rim upon disposal.

15. The lid of claim 14, wherein said lower surface of said flange of said plastic ring is semi-permanently attached to said upper surface of said lid rim by at least one of an adhesive, a polymeric film and a heat seal coating.

16. The lid of claim 14, wherein said plastic ring is injection molded onto said lid rim.

17. The lid of claim 14, wherein a bond formed between said lower surface of said flange of said plastic ring and said upper surface of said lid rim is adapted to be broken by a user such that said plastic ring may be separated from said lid rim upon disposal.

18. The lid of claim 14, wherein said lid rim includes a circumscribing outer edge that is generally identical in shape to a circumscribing outer edge of said container rim.

19. A method of manufacturing a lid adapted for placement over a container base having a peripheral container rim, said method comprising the steps of:
providing a paperboard material;
cutting a blank from said paperboard material;
die stamping said blank to form an upwardly extending cover portion and a generally flat and horizontal peripheral lid rim extending around at least a portion of said cover portion;
placing said formed paperboard blank in an injection molding machine; and
forming an injection molded plastic ring around at least a portion of said lid rim, wherein said plastic ring includes a horizontal flange disposed on an upper surface of said lid rim and a skirt depending downwardly therefrom.

20. The method of claim 19 further comprising the step of applying at least one of an adhesive, a polymeric film and a heat seal coating to said upper surface of said lid rim prior to placing said formed paperboard blank in said injection molding machine.

21. The lid of claim 19, wherein a bond formed between said upper surface of said lid rim and a lower surface of said flange of said plastic ring is adapted to be broken by a user such that said plastic ring may be separated from said lid rim upon disposal.
